(19) United States
(12) Patent Application Publication
(10) Pub. No.: US 2007/0209639 A1
(43) Pub. Date: Sep. 13, 2007

(54) Target fuel pressure setting apparatus for engine and method for setting the target fuel pressure

(75) Inventor: Kazuhiro Semii, Yokohama-shi (JP)

Correspondence Address: RADER, FISHMAN & GRAUER PLLC, 39533 WOODWARD AVENUE, SUITE 140, BLOOMFIELD HILLS, MI, 48304-0610, US

(73) Assignee: Nissan Motor Co., Ltd.

(21) Appl. No.: 11/715,023

(22) Filed: Mar. 7, 2007

(30) Foreign Application Priority Data
Mar. 8, 2006 (JP) 2006-063209

(51) Int. Cl. F02M 59/36

(52) U.S. Cl. 123/458; 123/457

(57) ABSTRACT

A fuel control apparatus and a method for setting a target fuel pressure are disclosed. A fuel delivery conduit accumulates fuel provided from a fuel pump. In turn, a fuel injector injects the fuel accumulated in the fuel delivery conduit while a fuel pressure regulator regulates fuel pressure in the fuel delivery conduit. There is a controller associated with the determination and control of the fuel pressure in the fuel delivery conduit based on at least one operating condition. The controller further selectively lowers the fuel pressure when the engine is in a fuel shortfall condition, where a fuel quantity capable of being injected under the fuel pressure falls short with respect to a desired fuel quantity of the engine.

### CROSS-REFERENCES TO RELATED APPLICATION

This application claims priority from Japanese Patent Application Serial No. Tokugan 2006-063209 filed Mar. 8, 2006, the entire contents of which is incorporated herein by reference.

### TECHNICAL FIELD

A target fuel pressure setting apparatus sets a target fuel pressure of an engine to which high-pressurized fuel produced by an engine-drive fuel pump is provided. A method sets a target fuel pressure.

### BACKGROUND

For in-cylinder injection type engines that directly jet or inject fuel into a cylinder, an extremely high fuel pressure is required. Because of this requirement, fuel discharged by a motor-drive feed pump (low pressure pump) is highly pressurized by an engine-drive plunger pump (high pressure pump), and the high-pressurized fuel is supplied to the engine.

Pressure changes in an engine cylinder depend on or according to at least one engine operating condition such as engine revolutions-per-minute (RPM) and load. Thus, usually, the fuel pressure is variably controlled according to the engine operating condition, and then is supplied to the engine. For example, the fuel pressure may be set as following. In a high speed range and at a high load range or area, the fuel pressure is set to a relatively high pressure. While in a low speed and at a low load range, the fuel pressure is set to a relatively low pressure. In a middle speed range and within a middle load range, the fuel pressure is set to a middle pressure range.

For an example of setting the fuel pressure, Japanese Patent Provisional Publication No. 2000-110621 (JP 2000-110621) is enclosed herein in its entirety.

### SUMMARY

In one aspect, a fuel control apparatus is disclosed. A fuel delivery conduit accumulates fuel provided from a fuel pump. In turn, a fuel injector injects the fuel accumulated in the fuel delivery conduit while a fuel pressure regulator regulates fuel pressure in the fuel delivery conduit. There is a controller associated with the determination and control of the fuel pressure in the fuel delivery conduit based on at least one operating condition. The controller further selectively lowers the fuel pressure when the engine is in a fuel shortfall condition, where a fuel quantity capable of being injected under the fuel pressure falls short with respect to a desired fuel quantity of the engine.

### BRIEF DESCRIPTION OF DRAWINGS

While the claims are not limited to the illustrated embodiments, an appreciation of various aspects of the system is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limiting or restricting to the precise form and configuration shown in the drawings and disclosed in the following detailed description. Exemplary embodiments of the present invention are described in detail by referring to the drawings as follows.

FIG. 1 is a drawing showing one embodiment of a fuel injection control apparatus (fuel providing apparatus).

FIG. 2 is a graph showing a relationship between a dischargeable fuel quantity of a plunger pump (high pressure pump) and a required fuel amount for an engine.

FIG. 3 is a graph showing a discharge efficiency of the plunger pump when varying fuel temperature and fuel pressure.

FIG. 4 shows a relationship between a theoretical discharge quantity and an actual discharge quantity of the plunger pump.

FIG. 5 is a flow chart that explains control logic of a controller.

FIG. 6A and 6B are examples of a fuel pressure map.

### DETAILED DESCRIPTION

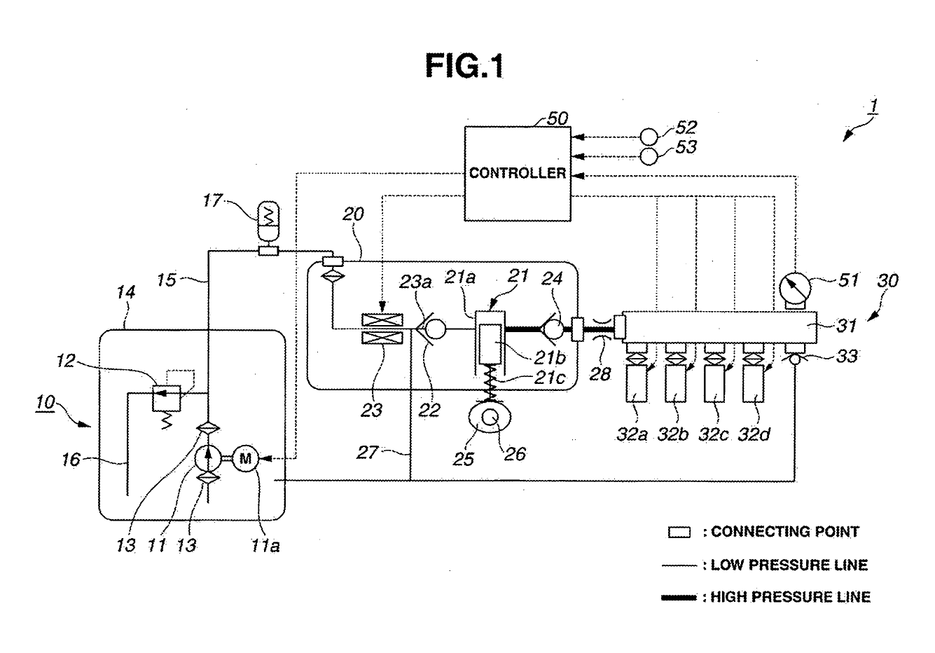

According to one aspect and as illustrated in FIG. 1, a fuel providing apparatus 1 for an engine comprises: a fuel pump; a fuel accumulation unit that accumulates a fuel provided from the fuel pump; a fuel injection valve that jets or injects the fuel accumulated in the fuel accumulation unit; a fuel pressure adjustment unit that adjusts a fuel pressure in the fuel accumulation unit; an operating condition detecting unit that detects an engine operating condition; and a controller that is connected to the fuel pressure adjustment unit and the operating condition detecting unit, and controls the fuel pressure in accordance with the operating condition. The controller lowers or reduces the fuel pressure when a condition occurs where a quantity shortage of the fuel provided to the engine under fuel pressure with respect to a required fuel quantity for the engine takes place.

According to another aspect, a fuel providing apparatus for an engine comprises: a fuel pump; a fuel accumulation unit that accumulates a fuel provided from the fuel pump; a fuel injection valve that jets or injects the fuel accumulated in the fuel accumulation unit; a fuel pressure adjustment unit that adjusts a fuel pressure in the fuel accumulation unit; an operating condition detecting unit that detects an engine operating condition; and a controller that is connected to the fuel pressure adjustment unit and the operating condition detecting unit, and controls the fuel pressure in accordance with the operating condition. The controller lowers the fuel pressure when a fuel temperature exceeds a specific temperature.

According to a further aspect, an engine comprises: a fuel providing apparatus having a fuel pump; a fuel accumulation unit that accumulates a fuel provided from the fuel pump; a fuel injection valve that jets or injects the fuel accumulated in the fuel accumulation unit; a fuel pressure adjustment unit that adjusts a fuel pressure in the fuel accumulation unit; an operating condition detecting unit that detects an engine operating condition; and a controller that is connected to the fuel pressure adjustment unit and the operating condition detecting unit, and controls the fuel pressure in accordance with the operating condition. The controller lowers the fuel pressure when a condition occurs where a quantity shortage of the fuel (i.e., a fuel shortfall) provided to the engine under the fuel pressure with respect to a required fuel quantity for the engine takes place.

According to a still further aspect, a fuel pressure control apparatus of a fuel provided to an engine, comprises: control means for controlling a fuel pressure according to an engine operating condition; and lowering means for lowering the fuel pressure when a condition occurs where a quantity shortage of the fuel provided to the engine under the fuel pressure with respect to a required fuel quantity for the engine occurs.

According to an additional aspect, a fuel providing apparatus for an engine, comprises: pumping means for pumping a fuel; fuel accumulation means for accumulating the fuel provided from the pumping means; fuel injection means for jetting or injecting the fuel accumulated in the fuel accumulating means; fuel pressure adjustment means for adjusting a fuel pressure in the fuel accumulation means; operating condition detection means for detecting at least one engine operating condition; and control means connected to the fuel pressure adjustment means and the operating condition detection means, for controlling the fuel pressure in accordance with the at least one operating condition. The control means lowers the fuel pressure when a condition occurs where a quantity shortage of the fuel provided to the engine under the fuel pressure with respect to a required fuel quantity for the engine takes place.

According to a still further aspect, a method for controlling a pressure of a fuel provided to an engine, the method comprises: controlling a fuel pressure in accordance with an engine operating condition; and lowering the fuel pressure when a condition occurs where a quantity shortage of the fuel provided to the engine under the fuel pressure with respect to a required fuel quantity for the engine takes place.

According to an additional aspect, a method for controlling a pressure of a fuel provided to an engine, the method comprises: controlling a fuel pressure in accordance with an engine operating condition; and lowering the fuel pressure when a fuel temperature exceeds a specific temperature.

Thus, it is possible to provide the fuel to the engine without occurrence of the fuel quantity shortage regardless of the engine operating condition, and to suppress cost up without the need for a plunger pump (high pressure pump) having high discharge performance.

More specifically, FIG. 1 is a drawing showing one embodiment of a fuel injection control apparatus.

A fuel injection control apparatus 1 has a fuel pumping unit 10, a fuel high-pressurizing unit 20, and a high pressure fuel injection unit 30.

The fuel pumping unit 10 has a feed pump (low pressure pump) 11, a pressure regulator 12, a fuel filter 13, and a fuel tank 14.

Fuel tank 14 houses feed pump 11 and pressure regulator 12, and stores fuel. Feed pump 11 is driven by an electric motor 11a, and provides or supplies the fuel in the fuel tank 14 to fuel high-pressurizing unit 20 through a fuel feed passage 15. Fuel filters 13 are arranged upstream and downstream of feed pump 11, respectively. Pressure regulator 12 is provided on a return passage 16 that diverges from fuel feed passage 15, and returns redundant or surplus fuel to fuel tank 14 in order for a discharge pressure of feed pump 11 not to become greater than or equal to a certain pressure. On fuel feed passage 15, a damper 17 is provided, and this damper 17 suppresses pressure pulsation of fuel feed passage 15.

Fuel high-pressurizing unit 20 has a plunger pump (high pressure pump) 21, a suction check valve 22, a spill adjustment solenoid 23 (a fuel pressure adjustment or control unit), and a discharge check valve 24.

Plunger pump 21 has a cylinder 21a, a plunger 21b, and a spring 21c. Plunger 21b moves upward and downward inside the cylinder 21a. In more detail, plunger 21b is moved according to a peripheral surface of a pump-drive cam (plate cam) 25. Pump-drive cam 25 is integrally formed with an intake-valve-use cam shaft 26. Intake-valve-use cam shaft 26 is driven by a crankshaft via an endless chain or a belt. Spring 21c urges or forces plunger 21b toward the peripheral surface of cam 25.

Suction check valve 22 is provided at a suction side of cylinder 21a. Suction check valve 22 prevents backflow of the fuel from cylinder 21a into fuel pumping unit 10.

Spill adjustment solenoid 23 controls a spill shaft 23a. Spill shaft 23a forcefully opens suction check valve 22. When suction check valve 22 is forcefully opened by spill shaft 23a, the fuel in cylinder 21a is turned to fuel tank 14 through a spill passage 27.

A discharge check valve 24 is provided at a discharge side of cylinder 21a. Discharge check valve 24 prevents backflow of the fuel from high pressure fuel injection unit 30 into cylinder 21a.

When plunger 21b moves downward inside the cylinder 21a according to the peripheral surface of pump-drive cam 25, fuel at a low pressure from feed pump 11 fills cylinder 21a through suction check valve 22. And when plunger 21b moves upward inside the cylinder 21a according to the peripheral surface of pump-drive cam 25, a pressure of the fuel in cylinder 21a increases and discharge check valve 24 opens. Further, a high pressurized fuel is provided to a delivery pipe 31 (a fuel delivery conduit) through an orifice 28 such that a pressure in delivery pipe 31 becomes high. Here, a discharge amount of plunger pump 21 is adjusted or controlled by spill adjustment solenoid 23. That is, if an open period or open duration of suction check valve 22 by means of spill shaft 23a is set to be long during the upward movement of plunger 21b, the amount (or quantity) of the fuel that is returned to fuel tank 14 through spill passage 27 is increased. And then the discharge quantity (amount) of plunger pump 21, that is, fuel supply (or fuel supply amount) to delivery pipe 31 is decreased. While, if the open duration of suction check valve 22 by means of spill shaft 23a is set to be short, the amount of the fuel that is returned to fuel tank 14 through spill passage 27 is decreased. And then, the discharge quantity of plunger pump 21, that is, the fuel supply amount to delivery pipe 31 is increased.

High pressure fuel injection unit 30 has the delivery pipe 31 and high pressure fuel injection valves (injectors) 32a to 32d.

Delivery pipe 31 stores the high pressure fuel discharged from plunger pump 21. The high pressure fuel stored in delivery pipe 31 is directly jetted or injected into cylinders of an engine from high pressure fuel injection valves 32a to 32d.

Delivery pipe 31 has a safety valve 33, This safety valve 33 opens when a fuel pressure in delivery pipe 31 exceeds a permissible or acceptable pressure, and returns some of the high pressure fuel in delivery pipe 31 to fuel tank 14. That is, the fuel pressure in delivery pipe 31 is controlled by way of the open/close of this safety valve 33.

Fuel temperature and fuel pressure in delivery pipe 31 are detected by a temperature pressure sensor 51. With respect to the temperature pressure sensor 51, a plurality of sensors could be provided to respectively detect the temperature and pressure. Or, for instance, one sensor might detect the pressure and the temperature might be calculated from the detected pressure (that is, the temperature is detected indirectly).

A controller 50 receives input signals from operating condition detecting units such as temperature pressure sensor 51, a crank angle sensor 52 and an accelerator pedal depression amount sensor 53, and then controls electric motor 11a, spill adjustment solenoid 23 and high pressure fuel injection valves (injectors) 32a to 32d. Controller 50 calculates an engine rotation speed (or engine RPM) on the basis of the signal of crank angle sensor 52. Further, controller 50 calculates a load based on the signal of accelerator pedal depression amount sensor 53. Controller 50 is formed by a microcomputer that has a central processing unit (CPU), read only memory (ROM), random access memory (RAM), and an input/output interface (I/O interface). Controller 50 may be formed by a plurality of the microcomputers.

The problem, which needs be resolved, will be described in some detail.

The fuel pumped by feed pump (low pressure pump) 11 is pressurized by plunger pump (high pressure pump) 21 to a high pressure. Once stored in delivery pipe 31 the fuel is then injected from high pressure fuel injection valves 32a to 32d. At this time, by changing or adjusting (or controlling) an injection pressure in accordance with engine operating condition, fuel economy and combustion or burning stability can be improved.

However, an actual injected fuel amount (quantity) changes or varies depending on at least engine operating condition (e.g., fuel temperature and/or fuel pressure). Because of this, even if a target fuel amount is set, in fact, the target fuel amount cannot be provided, and there is a possibility that fuel quantity shortage will arise.

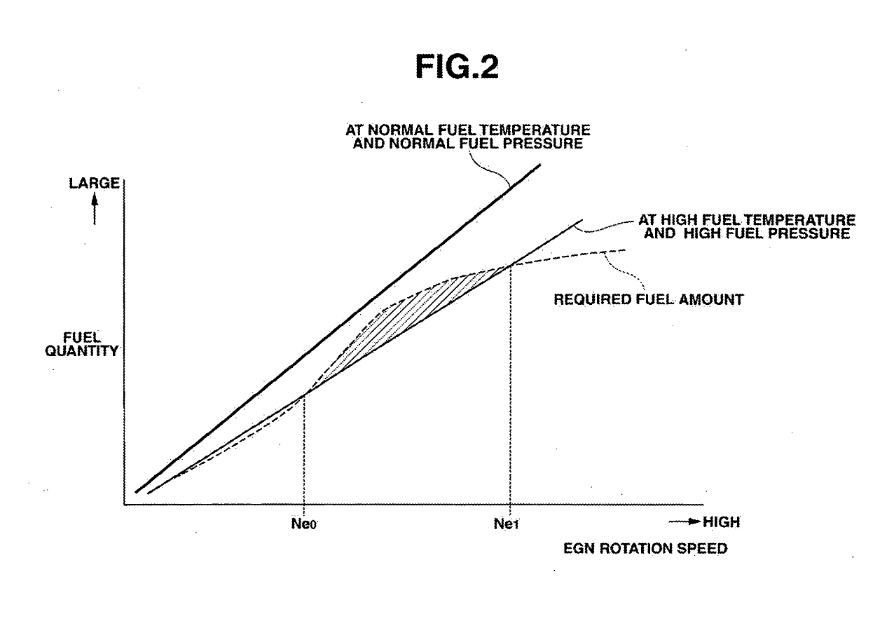

In more detail, this will be explained with reference to FIG. 2. FIG. 2 is a graph showing a relationship between a dischargeable fuel quantity of the plunger pump (high pressure pump) 21 and a required fuel amount for the engine. In FIG. 2, the thick line indicates a quantity (or amount) of the fuel which the plunger pump 21 can discharge under a normal fuel temperature and a normal fuel pressure condition. The thin line indicates a quantity (or amount) of the fuel which the plunger pump 21 can discharge under a high fuel temperature and high fuel pressure condition. The broken line indicates a required fuel amount (or quantity) for the engine at a certain constant load. This certain constant load is selected and indicated as a specific load at which a shortage of the dischargeable fuel quantity from the plunger pump 21 with respect to the required fuel amount for the engine arises depending on an engine rotational speed (engine RPM).

Since the plunger pump 21 is driven by the crankshaft of the engine, the discharge quantity of the plunger pump is proportional to the engine RPM.

When the fuel reaches a high fuel temperature and/or a high fuel pressure condition, the dischargeable fuel quantity of the plunger pump lowers or decreases (a gradient or slope of the graph is gentle) as compared with the normal fuel temperature and normal fuel pressure condition. And as seen in FIG. 2, an area where the fuel shortage with respect to the required fuel amount for the engine arises (a diagonally shaded area in FIG. 2) appears. In FIG. 2, the area of the shortage of the discharge amount appears within an engine RPM from Ne0 (approximately three thousand and a few hundred RPM) to Ne1 (approximately six thousand RPM). This is a noticeable phenomenon in an engine-drive (mechanical) pump that is driven by the engine crankshaft. However, when the same phenomenon is resolved by applying the teachings herein, it is not necessarily required that the pump be the engine-drive (mechanical) pump.

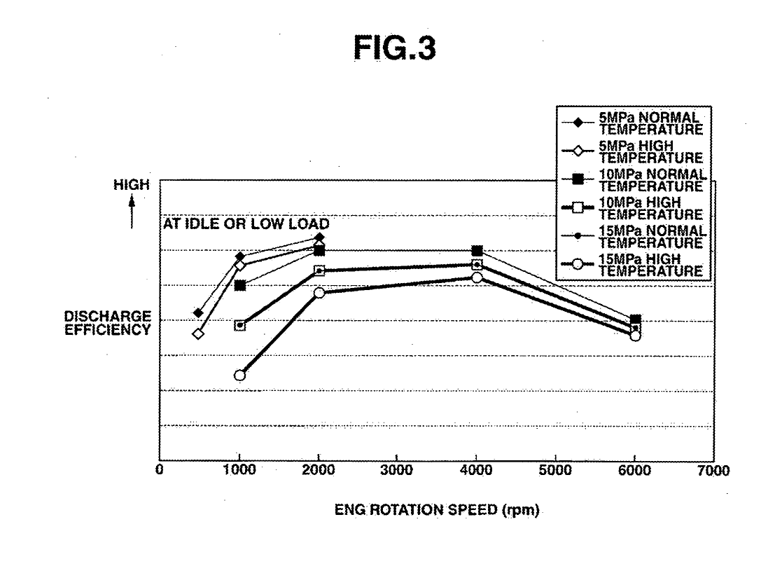

The approach to solving the indicated problem is explained with reference to FIG. 3. FIG. 3 is a graph showing a discharge efficiency of the plunger pump when varying fuel temperature and fuel pressure. In FIG. 3, diamond shaped marks indicate that the fuel pressure is 5 MPa. Square marks indicate that the fuel pressure is 10 MPa. Circles marks indicate that the fuel pressure is 15 MPa. Further, marks filled in with black and thin lines indicate that the fuel temperature is normal temperature (e.g., approximately 40 to 50° C.). Open marks (marks filled in with white) and thick lines indicate that the fuel temperature is at a high temperature (e.g., approximately 80 to 90° C).

Now, the discharge efficiency will be explained as follows.

Plunger pump 21 discharges the fuel by the upward and downward movement of plunger 21b in cylinder 21a as described above. A volume of movement of plunger 21b is a theoretical discharge quantity or amount. However, an actual discharge amount is less than the theoretical discharge amount. This ratio is the discharge efficiency. That is, the discharge efficiency is represented by the following expression.

e_{P}=V_{R}/V_{P} (Expression 1)
e_{P}; discharge efficiency
V_{R}; actual discharge amount
V_{P}; theoretical discharge amount

Here, the theoretical discharge amount is represented by the following expression.

V_{P}=π/4·D²l (Expression 2)
V_{P}; theoretical discharge amount
D; diameter of plunger
l; stroke amount of plunger

As can be seen in FIG. 3, in a case where the fuel temperature is constant, in more detail, in a case where the fuel temperature is constant at the normal temperature and the temperature is constant at the high temperature as well, the discharge efficiency decreases as the fuel pressure increases from 5 MPa→to 10 MPa→and to 15 MPa.

On the other hand, in a case where the fuel pressure is constant, in more detail, in a case where the fuel pressure is constant at 5 MPa and the fuel pressure is constant at 10 MPa and the fuel pressure is constant at 15 MPa as well, the discharge efficiency decreases as the fuel temperature increases from the normal temperature to the high temperature.

By the above characteristics, the discharge efficiency becomes low under a high fuel temperature and a high fuel pressure condition or some combination of the two. Since the theoretical discharge amount is constant, the discharge efficiency is proportional to the actual discharge amount. Therefore, a reason why the discharge efficiency is low under a high fuel temperature and/or a high fuel pressure condition is because the actual discharge amount decreases or is lowered.

A reason why the actual discharge amount decreases under high fuel temperature and/or a high fuel pressure will be explained below.

Firstly, a reason why the actual discharge amount decreases as the fuel temperature increases is discussed.

As described above, plunger pump 21 discharges the fuel by the upward and downward movement of plunger 21b in cylinder 21a. Therefore, the volume of movement of plunger 21b is the theoretical discharge amount. However, a density of the fuel becomes lower as the fuel temperature increases. The inventor et al. found that when the fuel temperature increases by 10° C., the density of the fuel substantially decreases by 1%. Thus, as the fuel temperature becomes higher, the actual discharge amount of the fuel (a number of molecules of fuel) which is actually discharged by way of the upward and downward movement of plunger 21b decreases.

Next, a reason why the actual discharge amount decreases as the fuel pressure increases is discussed.

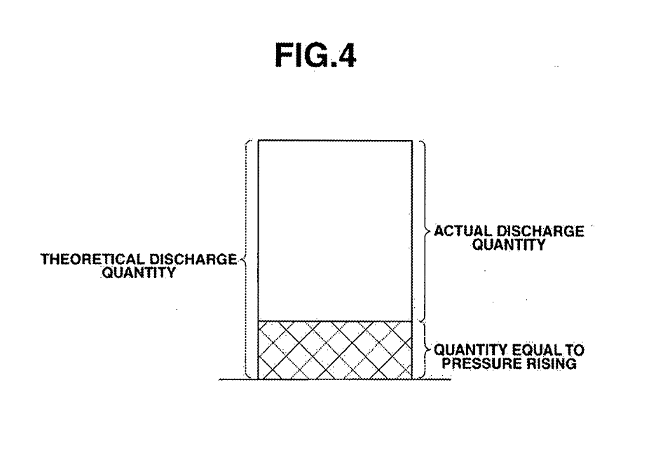

As described above, plunger pump 21 discharges the fuel by the upward and downward movement of plunger 21b in cylinder 21a. Therefore, the volume of movement of plunger 21b is the theoretical discharge amount. However, as shown in FIG. 4, some of the movement is consumed in raising pressure (for instance, some of the movement is consumed in lowering or decreasing a volume of the fuel), and the other (the rest) becomes the actual discharge amount. Therefore, the higher the fuel pressure becomes and the larger the amount or quantity equal to the pressure rising becomes, the smaller the actual discharge amount becomes. Further, as the fuel pressure becomes higher, the fuel temperature also increases. The actual discharge amount decreases by this too.

As explained above, regarding the actual discharge amount of the plunger pump, the higher the fuel temperature becomes and the higher the fuel pressure becomes, the lower the actual discharge amount becomes, and then the discharge efficiency decreases. And as shown in FIG. 2, the shortage of the fuel with respect to the required fuel amount for the engine arises depend on some combination of the engine operating conditions. Further, even if an engine control is carried out with setting the target fuel amount to be high under such conditions, a desired engine control can not be executed. Thus, in such situations, the fuel injection control apparatus (fuel providing apparatus) is configured to change a state of the fuel. That is to say, if it is possible to lower the fuel temperature and fuel pressure, the discharge efficiency can increase. However, it is difficult to easily lower the fuel temperature. Hence, the fuel injection control apparatus is configured to lower a target fuel pressure, and to inject fuel to the engine on the basis of the target fuel pressure.

On the other hand, if the target fuel pressure is decreased in this way, there is a possibility that the fuel economy will decrease or deteriorate. That is, an optimal combustion does not take place under an optimal fuel pressure condition, and then engine output is lowered. So, in order to achieve a target output, extra fuel is supplied. Because of this, the fuel economy could decrease. However, an operating range where such a control is required is restricted to within certain limits. As can be seen in FIG. 2, this limits are the range of the engine RPM from Ne0 (approximately three thousand and a few hundred RPM) to Ne1 (approximately six thousand RPM). Further, the shortage of the fuel discharge amount occurs only under the high fuel temperature and/or high fuel pressure conditions. In addition, as mentioned above, the load shown in FIG. 2 is part of the mere specific load at which the shortage of the dischargeable fuel quantity from the plunger pump with respect to the required fuel amount for the engine arises depend on the engine rotational speed (engine RPM).

When the engine RPM is lower than an operating range, as shown in FIG. 3, the discharge efficiency is low. However, as shown in FIG. 2, since the required fuel amount is small too, the quantity shortage of the fuel which can be actually provided, with respect to the required fuel amount for the engine, does not occur.

While, when the engine RPM is high, as shown in FIG. 3, as the engine RPM becomes higher, the discharge efficiency becomes lower. However, the difference in the discharge efficiency among the characteristics of different fuel temperatures and different fuel pressures becomes small. And their discharge efficiencies substantially become the same independently of the fuel temperature and the fuel pressure. Therefore, by increasing the target fuel amount for compensation (or, by compensating for or correcting the target fuel amount to an increased or extended fuel amount) in consideration of a reduction in the discharge efficiency caused by an increase of the engine RPM, as shown in FIG. 2, the quantity shortage of the fuel which can be actually provided, with respect to the required fuel amount for the engine, does not occur.

However, within the range from Ne0 (approximately three thousand and a few hundred RPM) to Ne1 (approximately six thousand RPM), the difference in the discharge efficiency is large due to the difference of the fuel temperature and/or the fuel pressure. In addition, the required fuel amount itself is large. The fuel quantity shortage therefore occurs depend on the at least one engine operating condition.

For such an operating range, it might be possible that the dischargeable fuel quantity could be increased. However, this requires a plunger pump having high discharge performance. It is not preferable to increase cost with usage of a high performance pump for the restricted or limited operating condition in which the engine RPM is within a predetermined range and also with the fuel temperature and/or the fuel pressure high.

Accordingly, in accordance with exemplary teachings, the operating range in which the fuel quantity shortage occurs due to the reduction of the discharge efficiency is determined, and in such an operating range, the pumping performance (i.e., avoidance of increased cost by way of a high performance pump) takes precedence over the fuel economy and the target fuel pressure is lowered or decreased. By controlling the engine on the basis of such a target fuel pressure, it is possible to suppress or limit the cost increase without using a plunger pump having high discharge performance.

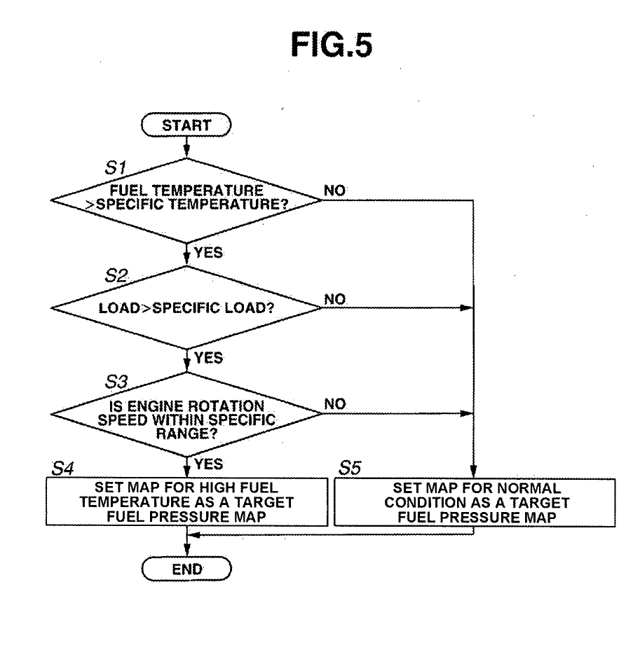

In the following, a control logic of controller 50 will be explained according to a flow chart in FIG. 5.

At step S1, controller 50 detects the fuel temperature, and determines or judges whether or not the detected fuel temperature is higher than a specific temperature. Here, the specific temperature is preset by experiment, and its data is stored in ROM. If the fuel temperature is high, the routine proceeds to step S2. While, if not, the routine proceeds to step S5.

At step S2, controller 50 determines whether or not an engine load is higher than a specific load. Here, the engine load is preset by experiment, and its data is stored in ROM. If the engine load is high load, the routine proceeds to step S3. While, if not, the routine proceeds to step S5.

At step S3, controller 50 determines whether or not the engine rotational speed is higher than a specific rotational speed. Here, the specific rotational speed is preset by experiment, and its data is stored in ROM. If the engine rotational speed is high rotational speed, the routine proceeds to step S4. While, if not, the routine proceeds to step S5.

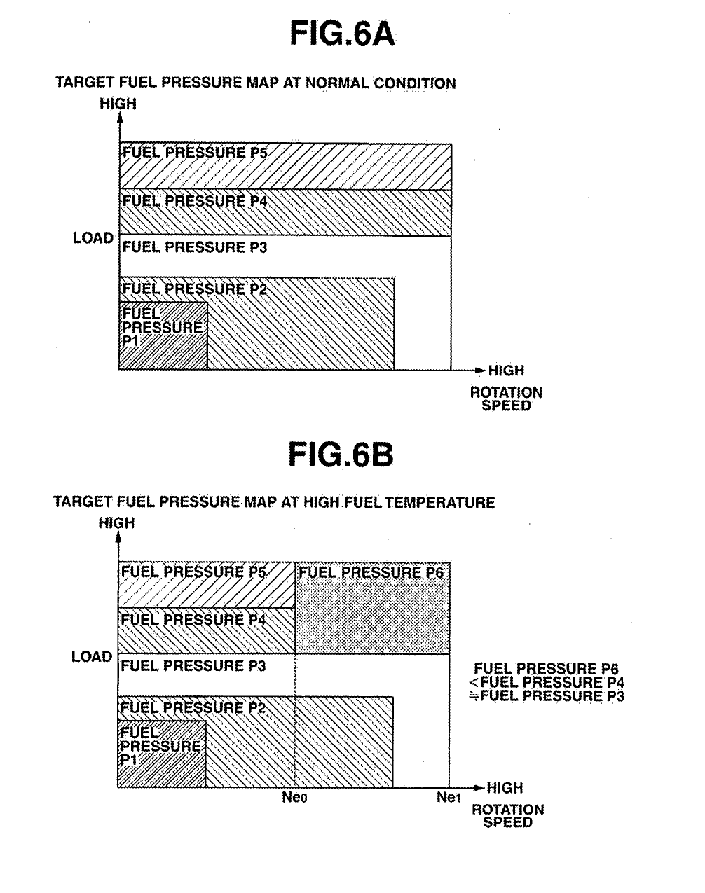

At step S4, controller 50 determines and then executes a fuel pressure control with usage of a target fuel pressure map for or at high water temperature as a fuel pressure map, shown in FIG. 6B.

At step S5, controller 50 determines and then executes the fuel pressure control with usage of a target fuel pressure map for or at normal condition as a fuel pressure map, shown in FIG. 6A.

Next, the fuel pressure maps shown in FIGS. 6A and 6B will be explained.

The map shown in FIG. 6A is the target fuel pressure map that is used under normal conditions. The map shown in FIG. 6B is the target fuel pressure map that is used at high fuel temperature. These maps are preset by experiment, and are stored in ROM.

A relationship between pressures P1, P2, P3, P4, P5, P6 is the following.

P1<P2<P3<P4<P5 (Expression 3)

P6<P4 and P6≈P3 (Expression 4)

Regarding the actual discharge amount of the plunger pump, the higher the fuel temperature becomes and the higher the fuel pressure becomes, the lower the actual discharge amount becomes. Thus, the discharge efficiency decreases. The shortage of the fuel with respect to the required fuel amount for the engine depends on the engine operating condition(s). Even if the engine control is carried out with setting the target fuel amount to be high under such conditions, the desired engine control cannot be executed. Thus, in such cases, the fuel injection control apparatus is configured to change the state of the fuel. That is to say, if it is possible to lower the fuel temperature and fuel pressure, the discharge efficiency can increase. However, it is difficult to easily lower the fuel temperature. Hence, the fuel injection control apparatus is preferably configured to lower the target fuel pressure, and to execute the engine on the basis of the target fuel pressure.

If the target fuel pressure is decreased in this way, there is a possibility that the fuel economy will decrease or deteriorate. However, the operating range where such a control is required is restricted within certain limits. The fuel quantity shortage occurs only under a high fuel temperature and/or high fuel pressure condition in the case of the engine RPM within a predetermined range and certain load.

For such an operating range, it might be possible that the dischargeable fuel quantity is increased. However, this requires the plunger pump having high discharge performance. It is not preferable to increase cost with usage of a high performance pump for a restricted or limited operating condition in which the engine RPM is within the predetermined range and also the fuel temperature and the fuel pressure are both high.

Accordingly, the operating range in which the fuel quantity shortage occurs due to the reduction of the discharge efficiency of the plunger pump is determined, and in such operating range, the pumping performance takes precedence over the fuel economy and the target fuel pressure is lowered or decreased. By controlling the engine on the basis of such target fuel pressure, it is possible to suppress or limit the cost increase without using the plunger pump having high discharge performance.

In addition, in ranges other than such a rare engine operating range, it is possible to increase the fuel economy and combustion or burning stability. Consequently, high fuel economy and high combustion stability can, on the whole, be obtained.

The preceding description has been presented only to illustrate and describe exemplary embodiments of the claimed invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed:

1. A fuel control apparatus for an engine comprising:
a fuel pump;
a fuel delivery conduit that accumulates fuel provided from the fuel pump;
a fuel injector that injects the fuel accumulated in the fuel delivery conduit;
a fuel pressure regulator that regulates a fuel pressure in the fuel delivery conduit; and
a controller associated with the determination and control of the fuel pressure in the fuel delivery conduit based on at least one operating condition, and
the controller further selectively lowering the fuel pressure when the engine is in a fuel shortfall condition, where a fuel quantity capable of being injected under the fuel pressure falls short with respect to a desired fuel quantity of the engine.

2. The fuel control apparatus as claimed in claim 1, wherein the controller determines a target fuel pressure according to the at least one engine operating condition, and controls the fuel pressure to be the target fuel pressure, the target fuel pressure is lowered when the fuel shortfall condition occurs.

3. The fuel control apparatus as claimed in claim 1, wherein the fuel shortfall condition is determined on the basis of a fuel temperature.

4. The fuel control apparatus as claimed in claim 3, wherein the fuel shortfall condition is determined when the fuel temperature is higher than a predetermined temperature.

5. The fuel control apparatus as claimed in claim 3, wherein the fuel shortfall condition is determined on the basis of an engine load.

6. The fuel control apparatus as claimed in claim 3, wherein the fuel shortfall condition is determined on the basis of an engine rotational speed.

7. The fuel control apparatus as claimed in claim 3, wherein the fuel shortfall condition is determined when an engine rotational speed and an engine load are within respective predetermined ranges and the fuel temperature is higher than a predetermined temperature.

8. The fuel control apparatus as claimed in claim 1, wherein the fuel pump is a mechanical pump driven by the engine.

9. The fuel control apparatus as claimed in claim 1, wherein the fuel is directly injected into an engine combustion chamber from the fuel injector.

10. A fuel control apparatus for an engine comprising:
a fuel pump;
a fuel delivery conduit that accumulates a fuel provided from the fuel pump;
a fuel injector that injects the fuel accumulated in the fuel delivery conduit;
a pressure regulator that regulates a fuel pressure in the fuel delivery conduit; and
a controller arranged and configured to determine and control the fuel pressure in the fuel delivery conduit in accordance with an engine operating condition, in which the fuel pressure in the fuel delivery conduit is lowered when a fuel temperature is higher than a predetermined fuel temperature.

11. The fuel control apparatus as claimed in claim 10, wherein when an engine rotational speed and an engine load are within respective predetermined ranges, the fuel pressure is lowered.

12. An engine comprising:
a fuel providing apparatus having
a fuel pump,
a fuel delivery conduit that accumulates a fuel provided from the fuel pump,
a fuel injector that injects the fuel accumulated in the fuel delivery conduit, and;
a fuel regulator that regulates a fuel pressure in the fuel delivery conduit; and
a controller arranged and configured to determine and regulate the fuel pressure in accordance with an engine operating condition, and further selectively and relatively reducing the fuel pressure when a fuel shortfall condition occurs, where a fuel quantity capable of being injected under the fuel pressure falls short with respect to a desired fuel quantity of the engine.

13. A fuel pressure control apparatus of a fuel provided to an engine, comprising:
control means for controlling a fuel pressure according to an engine operating condition; and
lowering means for lowering the fuel pressure when a condition occurs where a quantity shortage of the fuel provided to the engine under the fuel pressure with respect to a required fuel quantity for the engine occurs.

14. A fuel providing apparatus for an engine, comprising:
pumping means for pumping a fuel;
fuel accumulation means for accumulating the fuel provided from the pumping means;
fuel injection means for injecting the fuel accumulated in the fuel accumulating means;
fuel pressure adjustment means for adjusting a fuel pressure in the fuel accumulation means;
operating condition detection means for detecting at least one engine operating condition; and
control means for controlling the fuel pressure in accordance with the at least one operating condition, and
the control means lowering the fuel pressure when a condition occurs where a quantity shortage of the fuel provided to the engine under the fuel pressure with respect to a required fuel quantity for the engine occurs.

15. A method for controlling a pressure of a fuel provided to an engine, the method comprising:
determining and controlling a fuel pressure in accordance with at least one engine operating condition; and
lowering the fuel pressure when a fuel shortfall condition occurs where a fuel quantity capable of being provided to the engine under the fuel pressure falls short with respect to a required fuel quantity for the engine.

16. The method as claimed in claim 15, further comprising:
determining a target fuel pressure according to the at least one engine operating condition; and
controlling the fuel pressure to be the target fuel pressure, wherein the target fuel pressure is lowered when the fuel shortfall condition occurs.

17. The method as claimed in claim 15, wherein the fuel shortfall condition is determined on the basis of a fuel temperature.

18. The method as claimed in claim 17, wherein the fuel shortfall condition is determined by judging that the fuel temperature is higher than a specific temperature.

19. The method as claimed in claim 17, wherein the fuel shortfall condition is determined on the basis of an engine load.

20. The method as claimed in claim 17, wherein the fuel shortfall condition is determined on the basis of an engine rotational speed.

21. The method as claimed in claim 17, wherein the fuel shortfall condition is determined by judging that an engine rotational speed and an engine load are within predetermined ranges respectively and the fuel temperature is higher than a predetermined temperature.

22. The method as claimed in claim 15, wherein the fuel is provided a fuel pump driven by the engine.

23. The method as claimed in claim 15, wherein the fuel provided for the engine is directly injected into an engine combustion chamber.

24. A method for controlling a pressure of a fuel provided to an engine, the method comprising:
controlling a fuel pressure in accordance with an engine operating condition; and
lowering the fuel pressure when a fuel temperature exceeds a predetermined temperature.

25. The method as claimed in claim 24, wherein when an engine rotational speed and an engine load are within respective predetermined ranges, the fuel pressure is lowered.
